(19) United States
(12) Patent Application Publication
(10) Pub. No.: US 2020/0334640 A1
(43) Pub. Date: Oct. 22, 2020

(54) INTERACTIVE TOOL TO BOOK FOCUS TIME IN EMAIL

(71) Applicant: Microsoft Technology Licensing, LLC, Redmond, WA (US)

(72) Inventors: Anupama Challa, Redmond, WA (US); Nagendra Kalyan Nanduru, Redmond, WA (US); Kamal Janardhan, Redmond, WA (US); Helen Harmetz, Redmond, WA (US); Sourabh Chandak, Redmond, WA (US); Jiaming Wang, Redmond, WA (US); Soyeon Park, Redmond, WA (US); Jessica Hoang, Redmond, WA (US); Sandeep Seri, Bothell, WA (US); Chung Heong Gooi, Redmond, WA (US); Rajarshi Ray, Sammamish, WA (US)

(21) Appl. No.: 16/389,981

(22) Filed: Apr. 21, 2019

(51) Int. Cl. G06Q 10/10

(52) U.S. Cl. CPC G06Q 10/1095; G06Q 10/107

(57) ABSTRACT

A system and method for updating calendar data is described. A server accesses calendar data for a user account. The server identifies a plurality of available time slots from the calendar data based on identifying a plurality of contiguous available time slots within a preset time range and within a preset date range. Each contiguous available time slot has a duration of at least a preset number of consecutive hours. The server generates an inquiry email that indicates the plurality of available time slots. The server communicates the inquiry email to the user account.

### BACKGROUND

A user of an application may find it difficult to find available time by continuously checking on his/her schedule using a calendar application. For example, throughout the day, enterprise users receive many invitation requests for various meetings. This may result in little remaining time for the enterprise users to focus on their work uninterrupted from meetings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 is a block diagram illustrating a focus time engine in accordance with one example embodiment.

FIG. 3 is a block diagram illustrating a focus time tool in accordance with one example embodiment.

FIG. 4 is a flow diagram illustrating a method for generating an email identifying available time slots in accordance with one example embodiment.

FIG. 5 is a flow diagram illustrating a method for updating calendar data in accordance with one example embodiment.

FIG. 6 is a flow diagram illustrating a method for updating calendar data in accordance with one example embodiment.

FIG. 7 illustrates a routine in accordance with one embodiment.

FIG. 8 illustrates an example of a graphical user interface of a presentation and selection of available time slots in accordance with one example embodiment.

FIG. 9 is a diagrammatic representation of a machine in the form of a computer system within which a set of instructions may be executed for causing the machine to perform any one or more of the methodologies discussed herein, according to an example embodiment.

### DETAILED DESCRIPTION

In one embodiment, “processor” refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

In one embodiment, “signal Medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

In one embodiment, “Machine-Storage Medium” refers to a single or multiple storage devices and/or media (e.g., a centralized or distributed database, and/or associated caches and servers) that store executable instructions, routines and/or data. The term shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

In one embodiment, “Computer-Readable Medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

In one embodiment, “component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

In one embodiment, “Carrier Signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

In one embodiment, “Communication Network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The subject matter disclosed herein generally relates to a special-purpose machine that updates calendar data for a user account, including computerized variants of such special-purpose machines and improvements to such variants. Specifically, the present disclosure addresses systems and methods for an interactive tool to book focus time using email.

The present application describes a system for identifying and presenting available time slots in a calendar of a user account. Available time slots may refer to dates and times free of events (e.g., no appointments or meetings) on a calendar of a user account. The time slots may be identified in blocks of time such as, for example, at least two-hour blocks. These contiguous available time slots may also be referred to as “focus time” or “do not disturb time.” The focus time protects an enterprise user's time at work by reserving time for them to work uninterrupted and undistracted on his/her task or project. In one example embodiment, a server storing the calendar data identifies available time blocks (also referred to as open blocks) from the calendar of the user account. The server generates an email that identifies the available time blocks and provides the email to the user account (e.g., on a periodic basis—weekly). The user retrieves the email using an email application on a client device of the user. The email application may display the open blocks on the calendar of the user. The user can click on whichever block(s) he/she desires to book focus time. In another example embodiment, the email application may include an interactive tool (e.g., extensions or plug-in) that is triggered by the email and allows the user to see the open blocks on his/her calendar and click on whichever block(s) they desire to book focus time during. Upon one click in the body of the email, the interactive tool automatically books focus time during that time block. The interactive tool refreshes or updates in real-time open blocks in the calendar of the user account to reflect booked focus time. In another example embodiment, the user receives an email confirmation of the booked focus time.

The present application describes a system and method for updating calendar data. A server accesses calendar data for a user account and identifies a plurality of available time slots from the calendar data. The server generates an inquiry email that indicates the plurality of available time slots. The server communicates the inquiry email to the user account. The server receives, via the inquiry email, a selection of an available time slot from the plurality of available time slots. The calendar data for the user account is updated based on the selection of the available time slot. The server generates a confirmation email. The confirmation email confirms the selection of the available time slot and the updating of the calendar data. The server communicates the confirmation email to the user account.

As a result, one or more of the methodologies described herein facilitate solving the technical problem of identifying available time slots and securing those available time slots. As such, one or more of the methodologies described herein may obviate a need for certain efforts or computing resources. Examples of such computing resources include processor cycles, network traffic, memory usage, data storage capacity, power consumption, network bandwidth, and cooling capacity.

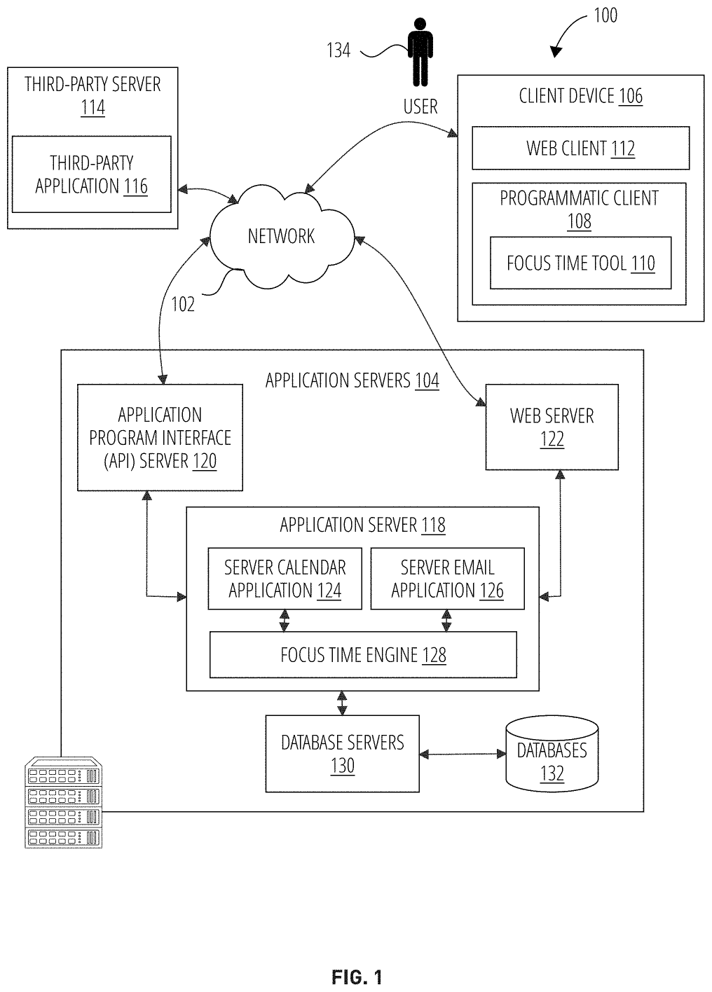

FIG. 1 is a diagrammatic representation of a network environment in which some example embodiments of the present disclosure may be implemented or deployed. One or more application servers 104 provide server-side functionality via a network 102 to a networked user device, in the form of a client device 106. A user 134 operates the client device 106. The client device 106 includes a web client 112 (e.g., a browser), a programmatic client 108 (e.g., an email/calendar application such as Microsoft Outlook™) that is hosted and executed on the client device 106. In one example embodiment, the programmatic client 108 includes a focus time tool 110 that enables the user to reserve or book available time slots from his/her calendar with one click.

For example, the focus time tool 110 identifies the available time slots and presents the available time slots by using a graphical user interface of the programmatic client 108 to visualize the available time slots in the context of the programmatic client 108 (e.g., email application). For example, the available time slots may be presented in a listing format, a time table format, a grid format, or a weekly calendar format. The focus time tool 110 enables the user 134 to select and reserve one of the identified available time slots with one click. For example, the user 134 can reserve one or more available time slots by clicking on the corresponding areas in the email. The focus time tool 110 may operate with the web client 112 and/or the programmatic client 108. In another example embodiment, the focus time tool 110 is part of the programmatic client 108 or web client 112. For example, the focus time tool 110 may operate as an extension or add on to the web client 112 or the programmatic client 108.

An Application Program Interface (API) server 120 and a web server 122 provide respective programmatic and web interfaces to application servers 104. A specific application server 118 hosts a server calendar application 124, a server email application 126, and a focus time engine 128. The server calendar application 124, the server email application 126, and the focus time engine 128 include components, modules and/or applications.

The server calendar application 124 stores and updates calendar data associated with a user account of the user 134. The server email application 126 stores and updates email data associated with the user account of the user 134.

In one example embodiment, the focus time engine 128 communicates with the server calendar application 124 to identify available time slots from the calendar of the user 134. The focus time engine 128 communicates the identified available time slots to the server email application 126. The server email application 126 communicates with the focus time tool 110 supported by the web server 122 to provide the identified available time slots to the programmatic client 108. In one example, the web client 112 communicate with the focus time engine 128, server calendar application 124, and server email application 126 via the programmatic interface provided by the Application Program Interface (API) server 120.

The third-party application 116 may, for example, be another cloud storage system. The application server 118 is shown to be communicatively coupled to database servers 130 that facilitates access to an information storage repository or databases 132. In an example embodiment, the databases 132 includes storage devices that store information to be published and/or processed by at least one of the server calendar application 124, the server email application 126, and the focus time engine 128.

Additionally, a third-party application 116 executing on a third-party server 114, is shown as having programmatic access to the application server 118 via the programmatic interface provided by the Application Program Interface (API) server 120. For example, the third-party application 116, using information retrieved from the application server 118, may supports one or more features or functions on a website hosted by the third party.

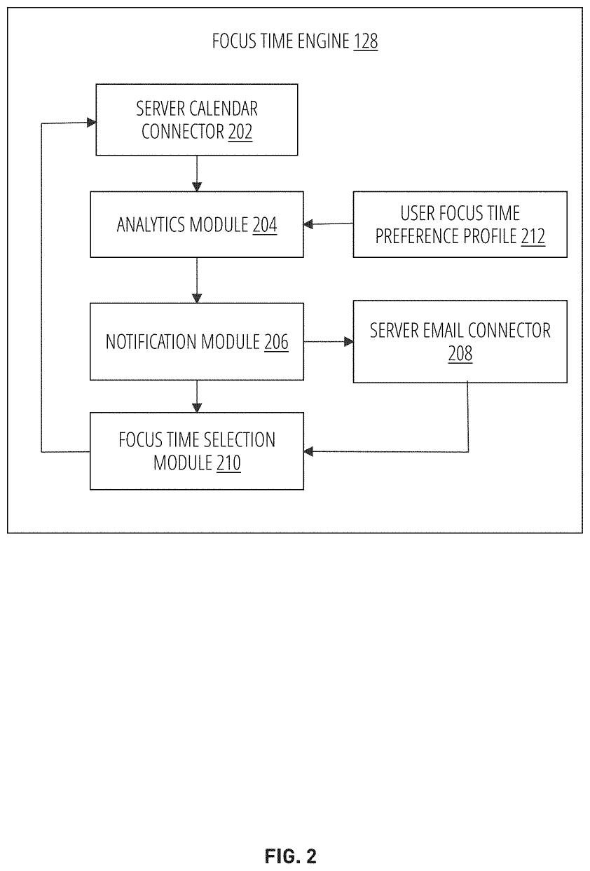

FIG. 2 is a block diagram illustrating a focus time engine in accordance with one example embodiment. The focus time engine 128 includes a server calendar connector 202, an analytics module 204, a notification module 206, a server email connector 208, a focus time selection module 210, and a user focus time preference profile 212.

The server calendar connector 202 communicates with the server calendar application 124 to access and update (e.g., read/write) calendar data associated with the user account of the user 134. For example, the server calendar connector 202 retrieves a preset calendar range (e.g., an upcoming weekly schedule of the user 134, a current monthly schedule).

The analytics module 204 analyzes the calendar data to determine available time slots. In one example embodiment, the analytics module 204 accesses a focus time preference of the user 134 from the user focus time preference profile 212. The focus time preference may indicate that the user 134 prefers focus time for example, of at least two continuous hours (e.g., two hours chunks), in the morning hours (e.g., between 6 am and 12 pm) every weekday. The analytics module 204 identifies available time slots based on the focus time preference within the preset calendar range (e.g., next week).

The notification module 206 identifies the available time slots. In one example embodiment, the notification module 206 identifies the available time slots in an email and include interactive areas (e.g., hyperlinks) that causes a corresponding function (e.g., book the available time slot) when the user clicks on the interactive area). In another example embodiment, the interactive area calls a function of an interactive tool (e.g., add on, extension) of the programmatic client 108 (e.g., email client) or the web client 112 (e.g., web browser). The interactive tool enables the user 134 to select and book a time slot.

The server email connector 208 renders the email that identifies the available time slots and communicates the email to the server email application 126. The server email application 126 sends the email to the client device 106 of the user 134. In another example embodiment, the server email connector 208 receives a selection email or a selection message from the programmatic client 108. The selection email or message identifies the time slot selected by the user 134.

The focus time selection module 210 receives the user selected time slot (e.g., via email or via other communication means from the client device 106) and instructs the server calendar connector 202 to update the calendar data of the user 134 based on the user selected time slot. For example, the focus time selection module 210 instructs the server calendar connector 202 to book or block out a time slot selected by the user 134 in the calendar of the user 134. The server calendar connector 202 communicates with the server calendar application 124 to instruct the server calendar application 124 to update the calendar data of the user 134.

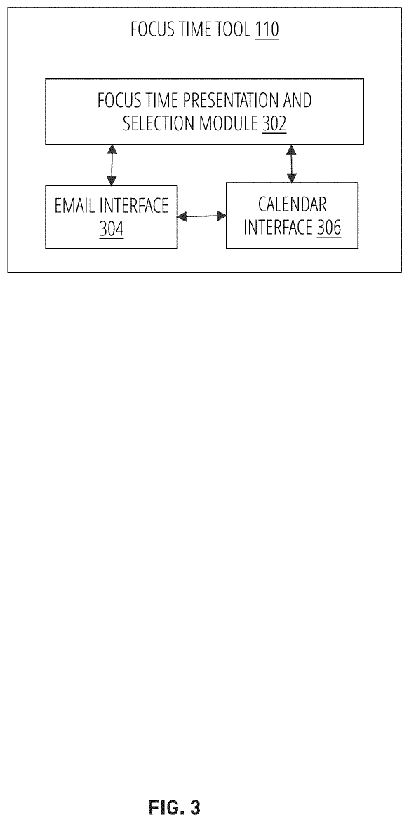

FIG. 3 is a block diagram illustrating a focus time tool 110 in accordance with one example embodiment. The focus time tool 110 includes a focus time presentation and selection module 302, an email interface 304, and a calendar interface 306. The focus time presentation and selection module 302 communicates with the email interface 304 and the calendar interface 306.

The focus time presentation and selection module 302 accesses the email from the focus time engine 128 via the email interface 304. The focus time presentation and selection module 302 presents the available time slots from the email. In another example embodiment, the focus time presentation and selection module 302 may visually present the available time slots in many ways (e.g., via cards, via other pop up dialog boxes, in a body of an email message).

The focus time presentation and selection module 302 further enables the user 134 to select at least one of the available time slots with one click. For example, the focus time presentation and selection module 302 identifies a selected time slot based on a click (in a corresponding area of the email message) from the user 134. The focus time presentation and selection module 302 communicates the selected time slot via the email interface 304, the calendar interface 306, or via other communication means to the focus time engine 128.

In one example embodiment, the email interface 304 communicates with a client email application (e.g., web client 112, programmatic client 108) operating at the client device 106. The calendar interface 306 communicates with a client calendar application (e.g., web client 112, programmatic client 108) operating at the client device 106). The email application stores email data from the server email application 126. The client calendar application stores calendar data from the server calendar application 124.

In another example embodiment, the focus time tool 110 includes functionalities from the focus time engine 128 and can operate without assistance from the application servers 104 (e.g., offline). For example, the focus time tool 110 performs similar functions from the modules described with respect to FIG. 2 (e.g., analytics module 204, the notification module 206, the focus time selection module 210, and the user focus time preference profile 212).

In another example embodiment, the focus time presentation and selection module 302 may access calendar data from the server calendar application 124 via the calendar interface 306. The focus time presentation and selection module 302 may display the selected focus time within the context of the calendar data (e.g., display within a calendar or table format).

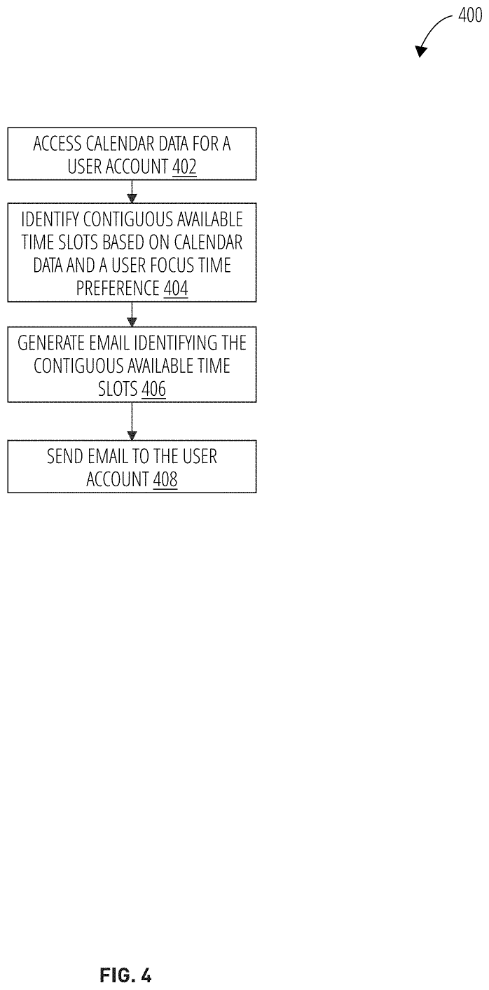

FIG. 4 is a flow diagram illustrating a method 400 for generating an email identifying available time slots in accordance with one example embodiment. Operations in the method 400 may be performed by the focus time engine 128, using components (e.g., modules, engines) described above with respect to FIG. 2. Accordingly, the method 400 is described by way of example with reference to the focus time engine 128. However, it shall be appreciated that at least some of the operations of the method 400 may be deployed on various other hardware configurations or be performed by similar components residing elsewhere. For example, some of the operations may be performed at the focus time tool 110.

At block 402, the focus time engine 128 accesses calendar data for a user account (e.g., user account of user 134). At block 404, the focus time engine 128 identifies contiguous available time slots based on the calendar data and a user focus time preference (e.g., minimum of 1.5 hours slots between 8 am and noon on Mondays and Fridays). At block 406, the focus time engine 128 generates an email identifying the contiguous available time slots. For example, the email includes interactive components that when selected cause the server calendar application 124 to book a selected time slot corresponding to the interactive components. At block 408, the focus time engine 128 sends the email to the user account.

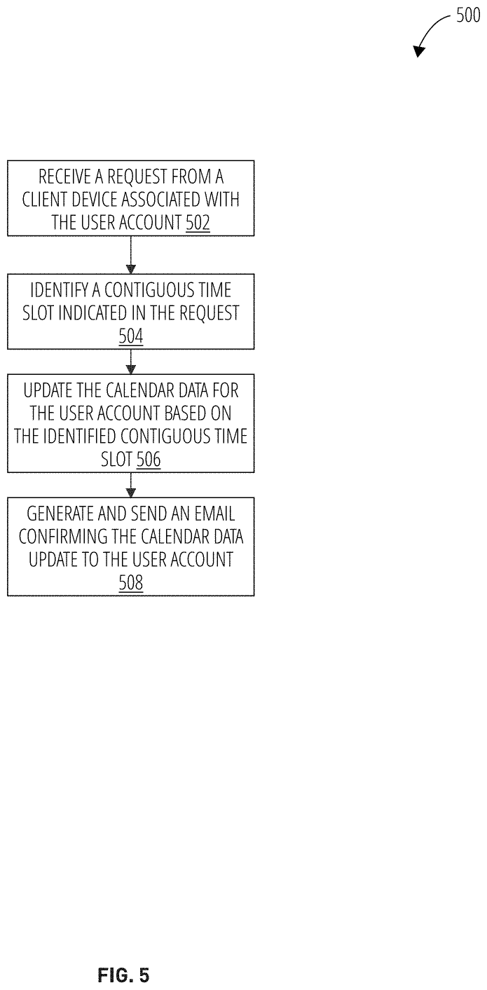

FIG. 5 is a flow diagram illustrating a method 500 for updating calendar data in accordance with one example embodiment. Operations in the method 500 may be performed by the focus time engine 128, using components (e.g., modules, engines) described above with respect to FIG. 2. Accordingly, the method 500 is described by way of example with reference to the focus time engine 128. However, it shall be appreciated that at least some of the operations of the method 500 may be deployed on various other hardware configurations or be performed by similar components residing elsewhere. For example, some of the operations may be performed at the focus time tool 110.

In block 502, the focus time tool 110 receives a request from the client device 106 associated with the user account of the user 134. The request may be in the form of an email, of a hyperlink call function, or from a tool operating at the client device 106. In block 504, the focus time tool 110 identifies the selected contiguous time slot indicated in the request. At block 506, the focus time tool 110 instructs the server calendar application 124 to updates the calendar of the user 134 based on the selected contiguous time slot (e.g., block out times to show as not-available or schedule a “do not disturb” meeting corresponding to the selected contiguous time slot). At block 508, the focus time tool 110 generates and seconds a confirmation email that confirms the updates to the calendar of the user 134.

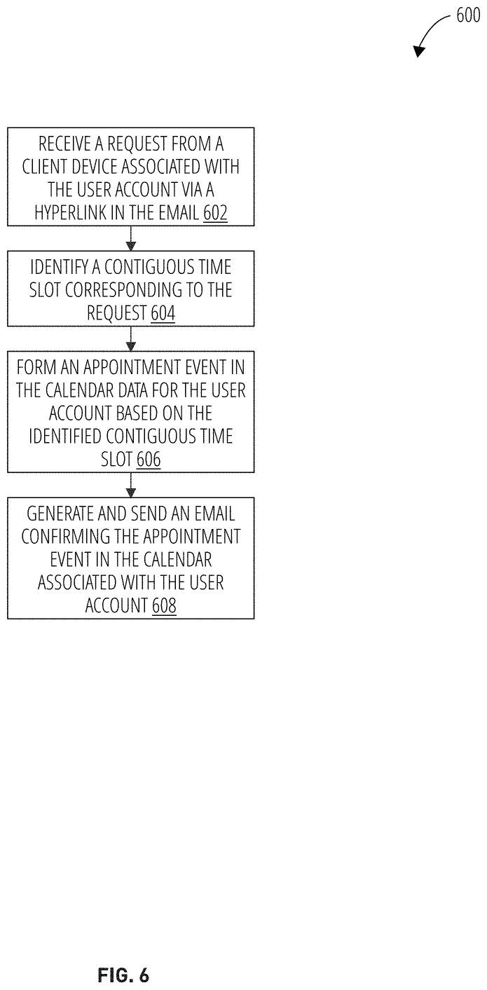

FIG. 6 is a flow diagram illustrating a method 600 for updating calendar data in accordance with one example embodiment. Operations in the method 600 may be performed by the focus time engine 128, using components (e.g., modules, engines) described above with respect to FIG. 2. Accordingly, the method 600 is described by way of example with reference to the focus time engine 128. However, it shall be appreciated that at least some of the operations of the method 600 may be deployed on various other hardware configurations or be performed by similar components residing elsewhere. For example, some of the operations may be performed at the focus time tool 110.

In block 602, the focus time tool 110 receives a request (via a hyperlink in an email) from the client device 106 associated with the user account of the user 134. In block 604, the focus time tool 110 identifies the selected contiguous time slot indicated in the request. At block 606, the focus time tool 110 forms an appointment event in the calendar data for the user account based on the identified contiguous time slot. At block 608, the focus time tool 110 generates and sends an email confirming the appointment event in the calendar of the user 134.

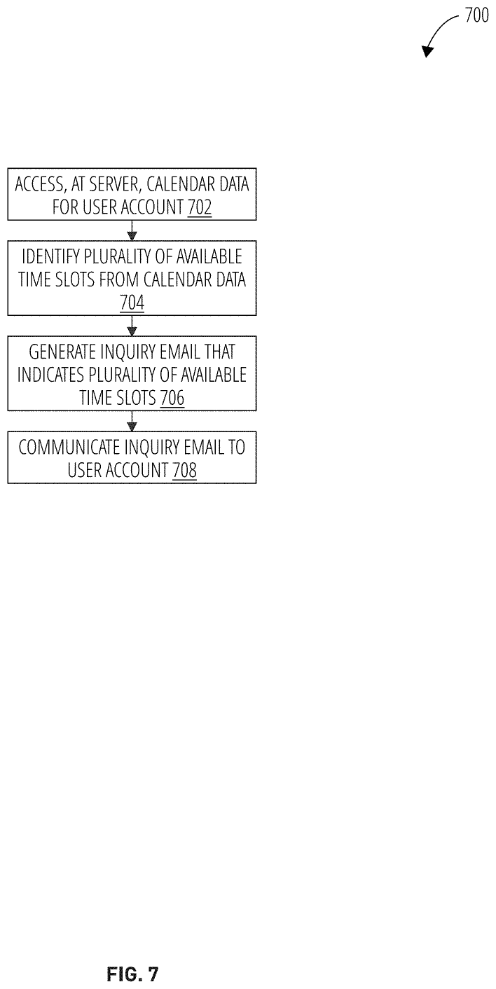

FIG. 7 illustrates a routine in accordance with one embodiment. In block 702, routine 700 accesses, at a server, calendar data for a user account. In block 704, routine 700 identifies a plurality of available time slots from the calendar data. In block 706, routine 700 generates an inquiry email that indicates the plurality of available time slots. In block 708, routine 700 communicates the inquiry email to the user account.

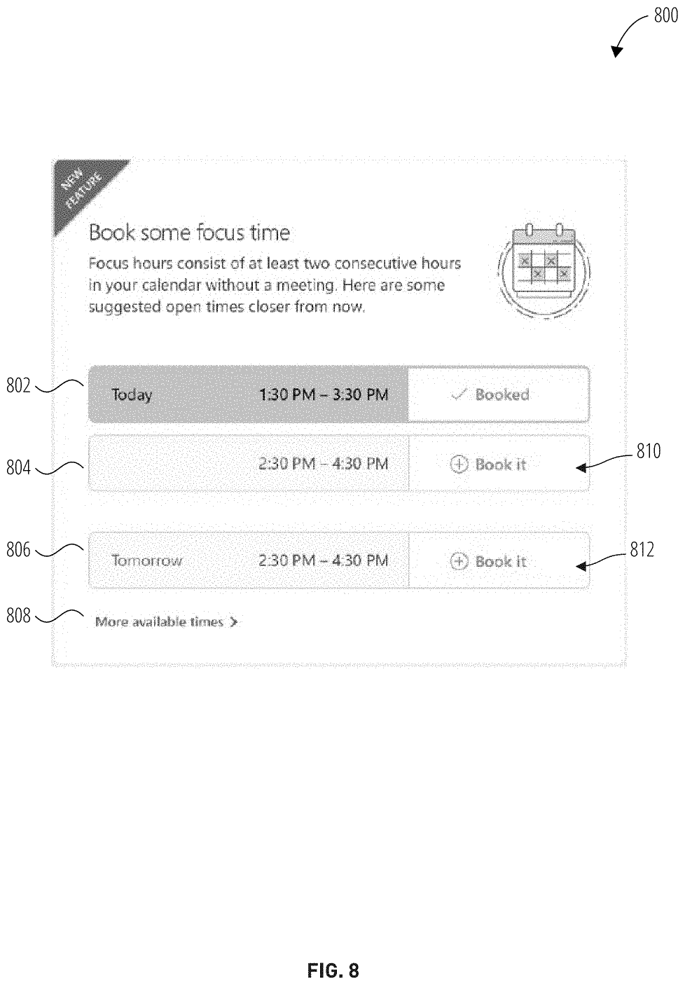

FIG. 8 illustrates an example of a graphical user interface 800 in accordance with one example embodiment. The graphical user interface 800 indicates time slot 802, time slot 804, time slot 806, and additional available time slots 808. The time slot 802 is confirmed as booked. The user can request to book or reserve the time slot 804 by clicking on the interactive area 810. The user can request to book or reserve the time slot 806 by clicking on the interactive area 812. The user can request to see additional time slots by clicking on the additional available time slots 808.

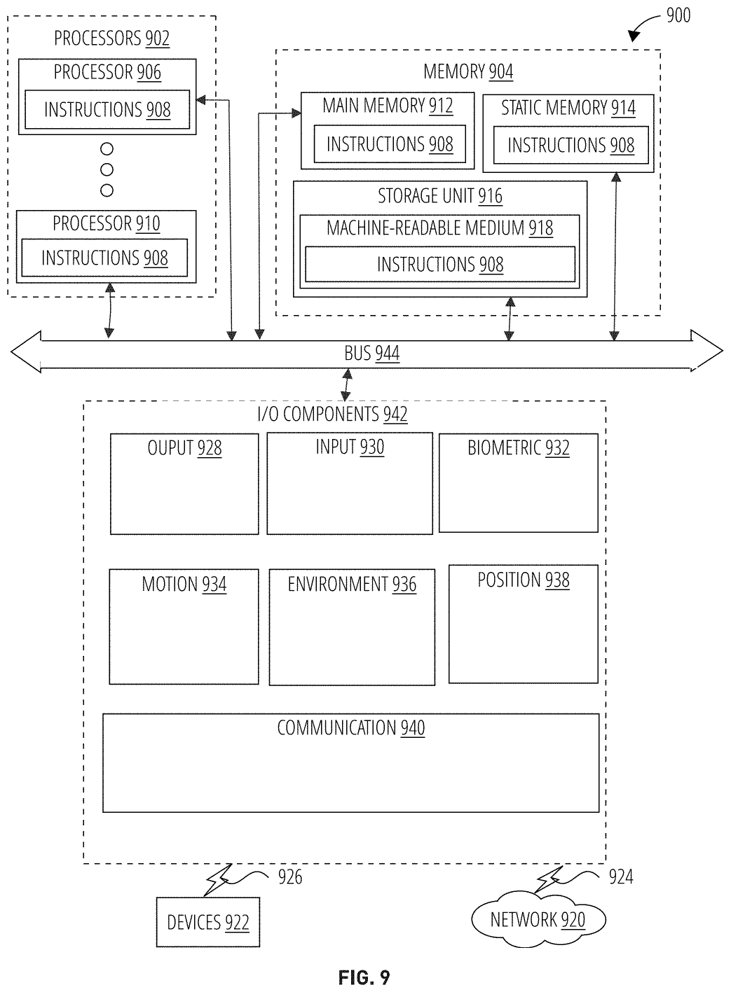

FIG. 9 is a diagrammatic representation of the machine 900 within which instructions 908 (e.g., software, a program, an application, an applet, an app, or other executable code) for causing the machine 900 to perform any one or more of the methodologies discussed herein may be executed. For example, the instructions 908 may cause the machine 900 to execute any one or more of the methods described herein. The instructions 908 transform the general, non-programmed machine 900 into a particular machine 900 programmed to carry out the described and illustrated functions in the manner described. The machine 900 may operate as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 908, sequentially or otherwise, that specify actions to be taken by the machine 900. Further, while only a single machine 900 is illustrated, the term “machine” shall also be taken to include a collection of machines that individually or jointly execute the instructions 908 to perform any one or more of the methodologies discussed herein.

The machine 900 may include processors 902, memory 904, and I/O components 942, which may be configured to communicate with each other via a bus 944. In an example embodiment, the processors 902 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 906 and a processor 910 that execute the instructions 908. The term “processor” is intended to include multi-core processors that may comprise two or more independent processors (sometimes referred to as “cores”) that may execute instructions contemporaneously. Although FIG. 9 shows multiple processors 902, the machine 900 may include a single processor with a single core, a single processor with multiple cores (e.g., a multi-core processor), multiple processors with a single core, multiple processors with multiples cores, or any combination thereof.

The memory 904 includes a main memory 912, a static memory 914, and a storage unit 916, both accessible to the processors 902 via the bus 944. The main memory 904, the static memory 914, and storage unit 916 store the instructions 908 embodying any one or more of the methodologies or functions described herein. The instructions 908 may also reside, completely or partially, within the main memory 912, within the static memory 914, within machine-readable medium 918 within the storage unit 916, within at least one of the processors 902 (e.g., within the processor's cache memory), or any suitable combination thereof, during execution thereof by the machine 900.

The I/O components 942 may include a wide variety of components to receive input, provide output, produce output, transmit information, exchange information, capture measurements, and so on. The specific I/O components 942 that are included in a particular machine will depend on the type of machine. For example, portable machines such as mobile phones may include a touch input device or other such input mechanisms, while a headless server machine will likely not include such a touch input device. It will be appreciated that the I/O components 942 may include many other components that are not shown in FIG. 9. In various example embodiments, the I/O components 942 may include output components 928 and input components 930. The output components 928 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 930 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 942 may include biometric components 932, motion components 934, environmental components 936, or position components 938, among a wide array of other components. For example, the biometric components 932 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 934 include acceleration sensor components (e.g., accelerometer), gravitation sensor components, rotation sensor components (e.g., gyroscope), and so forth. The environmental components 936 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 938 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 942 further include communication components 940 operable to couple the machine 900 to a network 920 or devices 922 via a coupling 924 and a coupling 926, respectively. For example, the communication components 940 may include a network interface component or another suitable device to interface with the network 920. In further examples, the communication components 940 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 922 may be another machine or any of a wide variety of peripheral devices (e.g., a peripheral device coupled via a USB).

Moreover, the communication components 940 may detect identifiers or include components operable to detect identifiers. For example, the communication components 940 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 940, such as location via Internet Protocol (IP) geolocation, location via Wi-Fi® signal triangulation, location via detecting an NFC beacon signal that may indicate a particular location, and so forth.

The various memories (e.g., memory 904, main memory 912, static memory 914, and/or memory of the processors 902) and/or storage unit 916 may store one or more sets of instructions and data structures (e.g., software) embodying or used by any one or more of the methodologies or functions described herein. These instructions (e.g., the instructions 908), when executed by processors 902, cause various operations to implement the disclosed embodiments.

The instructions 908 may be transmitted or received over the network 920, using a transmission medium, via a network interface device (e.g., a network interface component included in the communication components 940) and using any one of a number of well-known transfer protocols (e.g., hypertext transfer protocol (HTTP)). Similarly, the instructions 908 may be transmitted or received using a transmission medium via the coupling 926 (e.g., a peer-to-peer coupling) to the devices 922.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

### EXAMPLES

Example 1 is a computer-implemented method comprising: accessing, at a server, calendar data for a user account; identifying a plurality of available time slots from the calendar data based on identifying a plurality of contiguous available time slots within a preset time range and within a preset date range, each contiguous available time slot having a duration of at least a preset number of consecutive hours; generating an inquiry email that indicates the plurality of available time slots; and communicating the inquiry email to the user account.

Example 2 includes the subject matter of example 1, further comprising: receiving, via the inquiry email, a selection of an available time slot from the plurality of available time slots; and updating the calendar data for the user account based on the selection of the available time slot.

Example 3 includes the subject matter of example 2, further comprising: generating a confirmation email, the confirmation email confirming the selection of the available time slot and the updating of the calendar data; and communicating the confirmation email to the user account.

Example 4 includes the subject matter of example 2, wherein updating the calendar data further comprises: assigning an appointment event to the selection of the available time slot, the selected available time slot no longer being available after the assigning.

Example 5 includes the subject matter of example 1, wherein the inquiry email comprises a hyperlink corresponding to one of the available time slots.

Example 6 includes the subject matter of example 5, wherein the preset number of consecutive hours is based on a minimum available duration preference for the user account.

Example 7 includes the subject matter of example 1, further comprising: receiving a selection, within the inquiry email, of a request for an additional available time slot in addition to the plurality of available time slots; identifying a plurality of additional available time slots in addition to the plurality of available time slots from the calendar data; and communicating the plurality of additional available time slots.

Example 8 includes the subject matter of example 1, wherein the inquiry email identifies the plurality of available time slots and comprises corresponding clickable areas, the corresponding clickable areas configured to be activated by a user of the user account and to indicate a selection of an available time slot.

Example 9 includes the subject matter of example 1, wherein the calendar data identifies available time slots and non-available time slots, the non-available time slots indicating a corresponding appointment event.

Example 10 includes the subject matter of example 1, wherein the identifying of the plurality of available time slots and the generating of the inquiry email is performed periodically.

What is claimed is:

1. A computer-implemented method comprising:
accessing, at a server, calendar data for a user account;
identifying a plurality of available time slots from the calendar data based on identifying a plurality of contiguous available time slots within a preset time range and within a preset date range, each contiguous available time slot having a duration of at least a preset number of consecutive hours;
generating an inquiry email that indicates the plurality of available time slots; and
communicating the inquiry email to the user account.

2. The computer-implemented method of claim 1, further comprising:
receiving, using the inquiry email, a selection of an available time slot from the plurality of available time slots; and
updating the calendar data for the user account based on the selection of the available time slot.

3. The computer-implemented method of claim 2, further comprising:
generating a confirmation email, the confirmation email confirming the selection of the available time slot and the updating of the calendar data; and
communicating the confirmation email to the user account.

4. The computer-implemented method of claim 2, wherein updating the calendar data further comprises:
assigning an appointment event to the selection of the available time slot, the selected available time slot no longer being available after the assigning.

5. The computer-implemented method of claim 1, wherein the inquiry email comprises a hyperlink corresponding to one of the available time slots.

6. The computer-implemented method of claim 5, wherein the preset number of consecutive hours is based on a minimum available duration preference for the user account.

7. The computer-implemented method of claim 1, further comprising:
receiving a selection, within the inquiry email, of a request for an additional available time slot in addition to the plurality of available time slots;
identifying a plurality of additional available time slots in addition to the plurality of available time slots from the calendar data; and
communicating the plurality of additional available time slots.

8. The computer-implemented method of claim 1, wherein the inquiry email identifies the plurality of available time slots and comprises corresponding clickable areas, the corresponding clickable areas configured to be activated by a user of the user account and to indicate a selection of an available time slot.

9. The computer-implemented method of claim 1, wherein the calendar data identifies available time slots and non-available time slots, the non-available time slots indicating a corresponding appointment event.

10. The computer-implemented method of claim 1, wherein the identifying of the plurality of available time slots and the generating of the inquiry email is performed periodically.

11. A computing apparatus, the computing apparatus comprising:
a processor; and
a memory storing instructions that, when executed by the processor, configure the apparatus to:
access, at a server, calendar data for a user account;
identify a plurality of available time slots from the calendar data based on identifying a plurality of available time slots from the calendar data based on identifying a plurality of contiguous available time slots within a preset time range and within a preset date range, each contiguous available time slot having a duration of at least a preset number of consecutive hours;
generate an inquiry email that indicates the plurality of available time slots; and
communicate the inquiry email to the user account.

12. The computing apparatus of claim 11, wherein the instructions further configure the apparatus to:
receive, using the inquiry email, a selection of an available time slot from the plurality of available time slots; and
update the calendar data for the user account based on the selection of the available time slot.

13. The computing apparatus of claim 12, wherein the instructions further configure the apparatus to:
generate a confirmation email, the confirmation email confirming the selection of the available time slot and the updating of the calendar data; and
communicate the confirmation email to the user account.

14. The computing apparatus of claim 12, wherein updating the calendar data further comprises:
assign an appointment event to the selection of the available time slot, the selected available time slot no longer being available after the assigning.

15. The computing apparatus of claim 11, wherein the inquiry email comprises a hyperlink corresponding to one of the available time slots.

16. The computing apparatus of claim 15, wherein the preset number of consecutive hours is based on a minimum available duration preference for the user account.

17. The computing apparatus of claim 11, further comprising:
receive a selection, within the inquiry email, of a request for an additional available time slot in addition to the plurality of available time slots;
identify a plurality of additional available time slots in addition to the plurality of available time slots from the calendar data; and
communicate the plurality of additional available time slots.

18. The computing apparatus of claim 11, wherein the inquiry email identifies the plurality of available time slots and comprises corresponding clickable areas, the corresponding clickable areas configured to be activated by a user of the user account and to indicate a selection of an available time slot.

19. The computing apparatus of claim 11, wherein the calendar data identifies available time slots and non-available time slots, the non-available time slots indicate a corresponding appointment event.

20. A non-transitory computer-readable storage medium, the computer-readable storage medium including instructions that when executed by a computer, cause the computer to:
access, at a server, calendar data for a user account;
identify a plurality of available time slots from the calendar data based on identifying a plurality of contiguous available time slots within a preset time range and within a preset date range, each contiguous available time slot having a duration of at least a preset number of consecutive hours;
generate an inquiry email that indicates the plurality of available time slots; and
communicate the inquiry email to the user account.
